(19) United States
(12) Patent Application Publication
(10) Pub. No.: US 2015/0012746 A1
(43) Pub. Date: Jan. 8, 2015

(54) DETECTING USER PRESENCE ON SECURE IN-BAND CHANNELS

(71) Applicants: Amol A. Kulkarni, Hillsboro, OR (US); Sanjay Bakshi, Portland, OR (US); Ramkumar Venkatachary, Portland, OR (US)

(72) Inventors: Amol A. Kulkarni, Hillsboro, OR (US); Sanjay Bakshi, Portland, OR (US); Ramkumar Venkatachary, Portland, OR (US)

(21) Appl. No.: 13/933,292

(22) Filed: Jul. 2, 2013

(51) Int. Cl. H04L 29/06

(52) U.S. Cl. CPC H04L 63/0428
USPC 713/168

(57) ABSTRACT

A method for detecting a human user includes establishing a protected audio video path (PAVP) session between a client device and a server device. The method also includes encrypting the user presence object with keys associated with the PAVP session. The method further includes sending an encrypted user presence object to the client device via the PAVP session. Additionally, the method includes determining whether the human user is in proximity with the client device based on a response associated with the user presence object.

### TECHNICAL FIELD

The claimed subject matter relates generally to user presence technologies. More specifically, the claimed subject matter relates to detecting user presence on secure in-band channels.

### BACKGROUND ART

Many online services try to block automated requests for services because such requests can overwhelm the resources of the service. One example of such an abuse is automated requests from spammers. Spammers typically use computer programs, commonly referred to as bots, to obtain free email services for distributing spam.

User presence technologies help reduce such abuses by attempting to filter out automated users, such as bots. User presence technologies determine if a user is a computer program or a human being. One example of a user presence technology is the completely automated Public Turing Test to tell computers and humans apart (CAPTCHA). The CAPTCHA is typically a challenge-response test used to determine whether the test subject is a human user. CAPTCHA's attempt this determination by asking the user to complete a test that is designed to be simple for a human user, but difficult for a computer program. One common CAPTCHA asks a user to identify characters in a distorted image.

Over time, bots have become more sophisticated, and accordingly, better at outwitting user presence technologies. Thus, the ability of controlled systems to prevent abuses by bots has become more challenging, and hence, a greater drain on resources for many online services.

### BRIEF DESCRIPTION OF THE DRAWINGS

FIG. 1 is a block diagram of a protected audio video path (PAVP) in accordance with the claimed subject matter;

FIG. 2 is a block diagram of a system in accordance with embodiments of the claimed subject matter;

FIG. 3 is a process flow diagram for a method to perform user presence detection in accordance with embodiments; and

FIG. 4 is a block diagram of a computing device that may be used for user presence detection on a client computer, in accordance with embodiments.

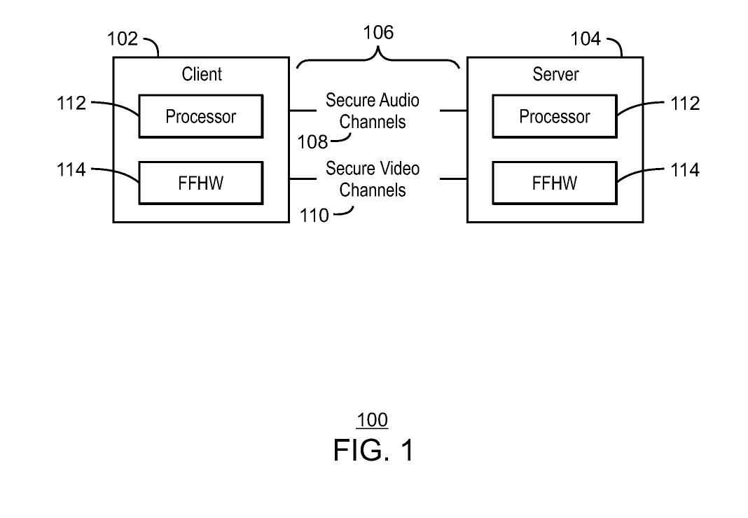

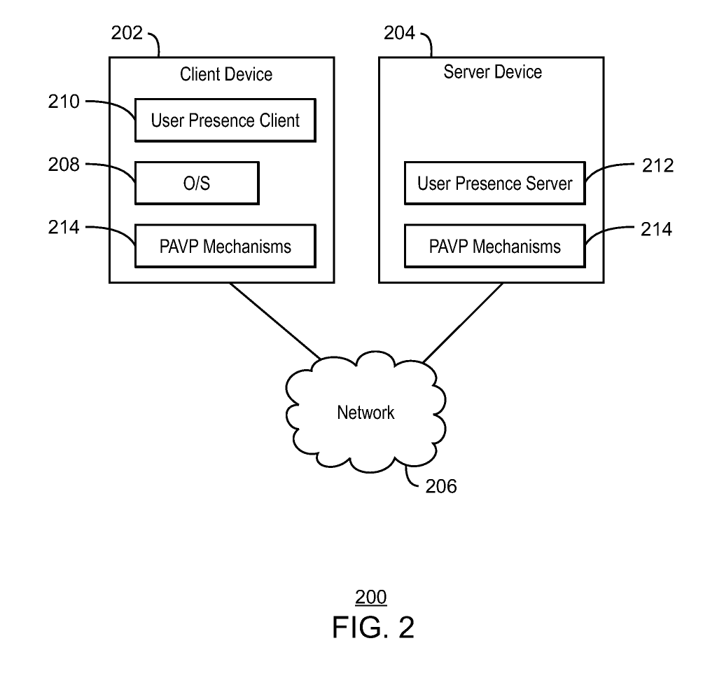

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following detailed description, numerous specific details are set forth in order to provide a thorough understanding. However, it will be apparent to one skilled in the art that embodiments may be practiced without these specific details. In other instances, well-known structures and devices are shown in block diagram form, rather than in detail, in order to avoid obscuring embodiments.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

In some embodiments, user presence technologies are delivered over the secure in-band channels of a protected audio video path (PAVP). The PAVP protects the data path within a computer during playback of secure video. In addition to securing the audio and video of protect content, such as movies, the security provided by the PAVP can be used to facilitate more dynamic implementations of user presence technologies. Instead of challenging users to decipher sometimes unreadable characters, some embodiments can provide more intuitive user presence technologies. Making user presence technologies more intuitive encourages more user participation in user detection, as traditional user presence technologies provide challenges beyond the capabilities of many human users. Greater participation improves the overall security of systems that implement the user presence technologies described herein.

Traditional user presence technologies are also referred to herein as out of band (OOB) technologies. The term OOB refers to the fact that traditional user presence technologies communicate over network channels that are outside of the bands of secure in-band channels.

FIG. 1 is a block diagram of a PAVP 100 in accordance with the claimed subject matter. The PAVP 100 includes a client 102 and a server 104, communicating over secure in-band channels 106. The secure in-band channels 106 include secure audio channels 108 and secure video channels 110. The client 102 and server 104 both include processors 112 and fixed function hardware 114. The data passed across the secure in-band channels 106 undergoes some pre-processing by the fixed function hardware 114, before being processed for playback by the processor 112. The processor 112 may include a graphics processor. Such a configuration of the PAVP 100 helps prevent audio and video data from being copied as the data passes through the various hardware components.

FIG. 2 is a block diagram of a system 200 in accordance with embodiments of the claimed subject matter. The system 200 includes a client device 202 and a server device 204 in communication over a network 206. The devices 202, 204 are computing devices. The client devices 202 are typically desktop computers, laptops, tablets, or smart phones, but may include other computing devices capable of communications with the server device 204 using a PAVP. The server device 204 is typically a server, but may include other computing devices that provide a secure operating environment.

The client device 202 includes an a user presence client operating system 210, operating system 210, and PAVP mechanisms 214. The operating system 210 is software that manages hardware resources on a computing device, such as the client device 202, and server device 204. The operating system 210 also provides common services for computer programs run on a computing device.

When the user attempts to acquire some service, the user may encounter a login screen, a user consent form, or some indication of acknowledgement or verification requested by the service provider. User presence technologies are typically employed in such scenarios.

The user presence client 208 is software that communicates via the operating system 210 over the secure in-band channels 106 with a user presence server 212 to determine whether a human user is present at the client device 202. The user presence server 212 is software running on the server device 204. In one embodiment, the user presence server 212 generates an image for display by the user presence client 208. The human user provides an oral description of the image, which is validated by the user presence server 212 to make the determination.

User presence technologies may also be expanded to those with impaired vision. In some embodiments, the user presence server 212 generates an audio file that provides directions for a human user to follow. For example, the user could be directed to click a specific location on a screen. The human response could be expanded to other devices besides the client device 202. For example, a human user operating a desktop computer could be directed to place a phone call or send a text message, for example.

Because both audio and visual data may be used, user presence technologies could incorporate a variety of multimedia presentations, games, or any type of user presence challenge that could be delivered through audio-video playback, or web clients, such as with the HTML5 standard.

The user presence client 208 may be a web browser, an application, or any other software capable of the user presence client technologies described herein.

The PAVP mechanisms 214 include hardware and software components that encrypt audio and video data to make such data inaccessible to the operating system 206. Because the encrypted data is not accessible to the operating system 206, the encrypted data is also not accessible to any malware that may be running on the client device 202.

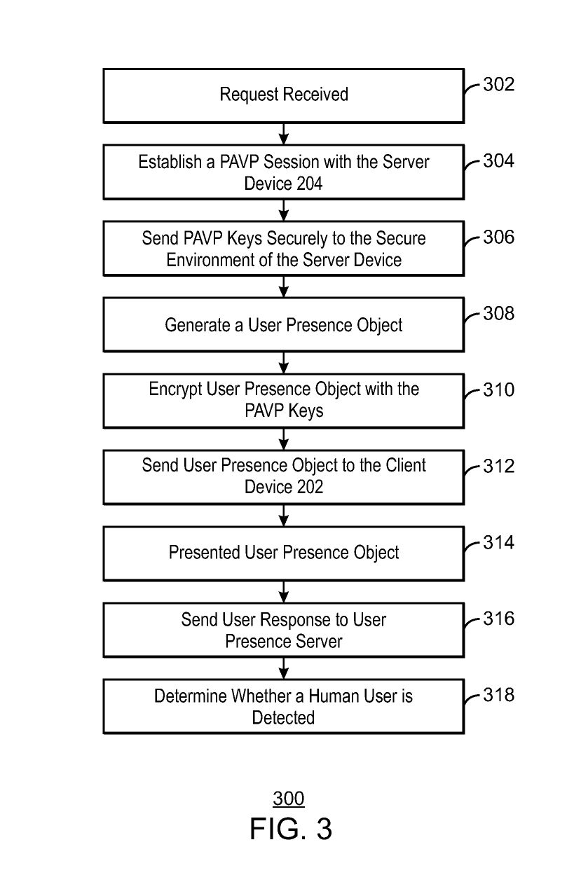

FIG. 3 is a process flow diagram for a method 300 to perform user presence detection in accordance with embodiments. The method begins at block 302, where a request for a service is received. The request may be a request to create a free email account. At block 304, the client device 202 may establish a PAVP session with the server device 204.

At block 306, the user presence client 208 sends PAVP keys securely to the secure environment of the server device 204. At block 308, the user presence server 212 generates a user presence object. The user presence object may be an image, an audio presentation, an audio and visual display, a game, and so on.

At block 310, the user presence object is encrypted with the PAVP keys. At block 312, the user presence object is sent to the client device 202. At block 314, the object is presented by the user presence client 208. As stated previously, audio files, video files, images, and so on may be play or presented.

At block 316, the user's response is sent to the user presence server 212 to determine whether a human user is detected. Additionally, a corresponding response may be sent, such as denying a service requested by a non-human user.

The process shown in FIG. 3 may be implemented in any suitable hardware, including logic circuits, one or more processors configured to execute computer-readable instructions, and the like.

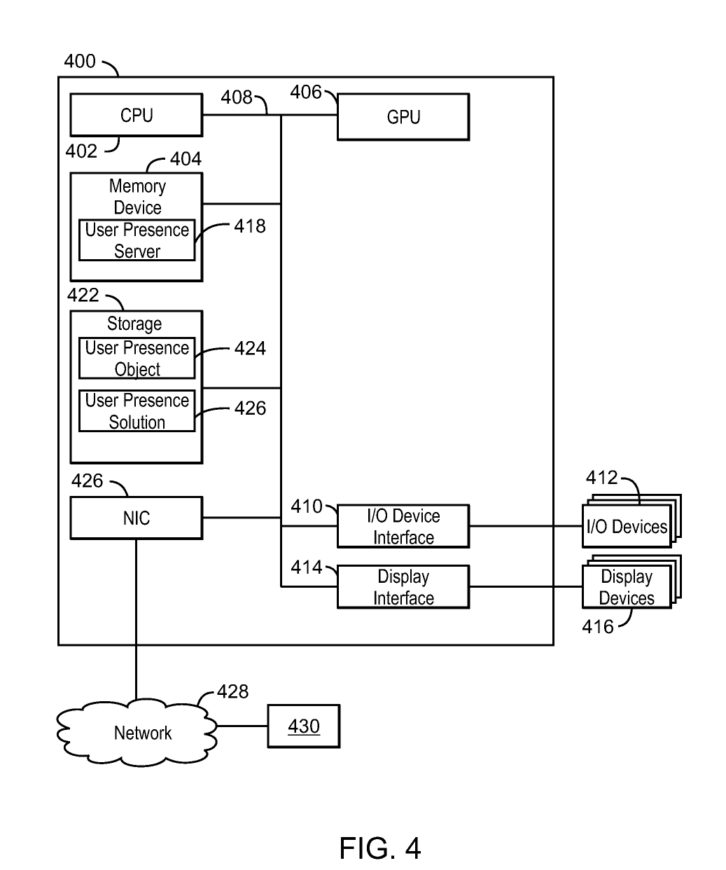

FIG. 4 is a block diagram of a server 400 that may be used for user presence detection on a client computer 430, in accordance with embodiments. The server 400 may be a computing device such as, a laptop computer, desktop computer, tablet computer, and server rack, among others. The server 400 may include a central processing unit (CPU) 402 that is configured to execute stored instructions, as well as a memory device 404 that stores instructions that are executable by the CPU 402. The CPU 402 can be a single core processor, a multi-core processor, a computing cluster, or any number of other configurations. Furthermore, the server 400 may include more than one CPU 402. The memory device 404 can include random access memory (RAM), read only memory (ROM), flash memory, or any other suitable memory systems. For example, the memory device 404 may include dynamic random access memory (DRAM).

The server 400 may also include a graphics processing unit (GPU) 406. As shown, the CPU 402 may be connected through a bus 408 to the GPU 406. The GPU 406 may be configured to perform any number of graphics operations within the server 400. The GPU 406 may be configured to render or manipulate graphics images, graphics frames, videos, or the like, to be displayed to a user of the server 400.

The CPU 402 may be connected through the bus 408 to other input/output (I/O) components using an I/O device interface 410 configured to connect the server 400 to one or more I/O devices 412. The I/O devices 412 may include, for example, a keyboard and a pointing device, wherein the pointing device may include a touchpad or a touchscreen, among others. I/O devices 412 may be built-in components of the server 400, or may be devices that are externally connected to the server 400.

The CPU 402 may also be linked through the bus 408 to a display interface 414 configured to connect the server 400 to a display device 416. The display device 416 may include a display screen that is a built-in component of the server 400. The display device 416 may also include a computer monitor, television, or projector, among others, that is externally connected to the server 400.

The memory device 404 may include a user presence server 418. The user presence server 418 determines whether a human user is operating a client device in communication with the server 400.

The server 400 may also include a storage device 422. The storage device 422 is a physical memory such as a hard drive, an optical drive, a thumbdrive, an array of drives, or any combinations thereof. The storage device 422 may also include remote storage drives. The storage device 422 may also include numerous user presence objects 424 and corresponding user presence solutions 426. The user presence solutions 426 may specify the solutions that indicate the user may be present. The user presence objects 424 are sent for presentation on the client device. The responses to the user presence object 424 may be matched against the corresponding user presence solution 426.

The block diagram of FIG. 4 is not intended to indicate that the server 400 is to include all of the components shown in FIG. 4. Further, the server 400 may include any number of additional components not shown in FIG. 4, depending on the details of the specific implementation.

It is to be understood that specifics in the aforementioned examples may be used anywhere in one or more embodiments. For instance, features of the computing device described above may alternatively be implemented with respect to either of the methods or the computer-readable medium described herein. Furthermore, although the Figures herein describe embodiments, embodiments of the claimed subject matter are not limited to those diagrams or corresponding descriptions. For example, flow need not move through each illustrated box of FIG. 4 in the same specific order as illustrated herein.

Embodiments are not restricted to the particular details listed herein. Indeed, those skilled in the art having the benefit of this disclosure will appreciate that many other variations from the foregoing description and drawings may be made. Accordingly, it is the following claims, including any amendments thereto, that define the scope.

What is claimed is:

1. A method for detecting a human user, comprising:
establishing a protected audio video path (PAVP) session between a client device and a server device;
encrypting a user presence object with keys associated with the PAVP session;
sending an encrypted user presence object to the client device via the PAVP session; and
determining whether the human user is in proximity with the client device based on a response associated with the user presence object.

2. The method of claim 1, wherein the user presence object comprises an image, and wherein the response comprises an audio response from the human user.

3. The method of claim 1, wherein the user presence object comprises an audio playback, and wherein the response comprises a sequence of selections on the client device by the human user.

4. The method of claim 1, wherein the user presence object comprises a software application, wherein the software application instructs the human user to provide the response.

5. The method of claim 4, wherein the software application comprises hypertext markup language 5 code.

6. The method of claim 1, comprising presenting the user presence object on the client device.

7. The method of claim 1, comprising recording an audio response by the human user, wherein the response comprises the audio response.

8. The method of claim 7, wherein determining whether the human user is in proximity with the client device comprises performing speech recognition for the audio response.

9. A system, comprising:
a processor; and
a memory comprising computer-executable instructions configured to cause the processor to:
establish a protected audio video path (PAVP) session between a client device and a server device;
encrypt the user presence object with keys associated with the PAVP session;
send an encrypted user presence object to the client device via the PAVP session; and
determine whether the human user is in proximity with the client device based on a response associated with the user presence object.

10. The system of claim 9, wherein the user presence object comprises an image, and wherein the response comprises an audio response from the human user.

11. The system of claim 9, wherein the user presence object comprises an audio playback, and wherein the response comprises a sequence of selections on the client device by the human user.

12. The system of claim 9, wherein the user presence object comprises a software application, wherein the software application instructs the human user to provide the response.

13. The system of claim 12, wherein the software application comprises hypertext markup language 5 code.

14. The system of claim 9, comprising code configured to present the user presence object on the client device.

15. The system of claim 9, comprising code configured to record an audio response by the human user, wherein the response comprises the audio response.

16. The system of claim 15, wherein determining whether the human user is in proximity with the client device comprises performing speech recognition for the audio response.

17. A computer-readable medium, comprising code configured to cause a processor to:
establish a protected audio video path (PAVP) session between a client device and a server device;
encrypt the user presence object with keys associated with the PAVP session;
send an encrypted user presence object to the client device via the PAVP session; and
determine whether the human user is in proximity with the client device based on a response associated with the user presence object.

18. The computer-readable medium of claim 17, wherein the user presence object comprises an image, and wherein the response comprises an audio response from the human user.

19. The computer-readable medium of claim 17, wherein the user presence object comprises an audio playback, and wherein the response comprises a sequence of selections on the client device by the human user.

20. The computer-readable medium of claim 17, wherein the user presence object comprises a software application, wherein the software application instructs the human user to provide the response.

21. A protected audio video path (PAVP) for detecting user presence, comprising:
a client device configured to establish a PAVP session between the client device and a server device; and
the server device, configured to:
encrypt a user presence object with keys associated with the PAVP session;
send an encrypted user presence object to the client device via the PAVP session; and
determine whether the human user is in proximity with the client device based on a response associated with the user presence object.

22. The PAVP of claim 21, wherein the client device is configured to present the user presence object.

23. The PAVP of claim 21, wherein the user presence object comprises a software application, wherein the software application instructs the human user to provide the response.

24. The PAVP of claim 23, wherein the software application comprises hypertext markup language 5 code.
